(19) United States
(12) Patent Application Publication
(10) Pub. No.: US 2005/0177565 A1
(43) Pub. Date: Aug. 11, 2005

(54) Salesperson selecting equipment and method for selecting salesperson

(76) Inventor: Mantaro Akamatsu, Kyotanabe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/047,623

(22) Filed: Feb. 2, 2005

(30) Foreign Application Priority Data
Feb. 6, 2004 (JP) 2004-030347

(51) Int. Cl. G06F 17/30

(52) U.S. Cl. 707/4

(57) ABSTRACT

Salesperson selecting equipment including a client data storage section for storing client data that are data on one or more clients; a client assessment calculation section for calculating client assessment that is assessment on the client, based on the client data; a salesperson data storage section for storing salesperson data that are data on a plurality of salespersons of a sales company; a salesperson assessment calculation section for calculating salesperson assessment that is assessment on the salesperson for each of the salespersons, based on the salesperson data; a selecting section for selecting the salesperson to carry out sales to the client, based on the client assessment and the salesperson assessment; and an output section for outputting results selected by the selecting section. According to this salesperson selecting equipment, it is possible to select a salesperson suitable for carrying out sales to a client.

### TECHNICAL FIELD

### FIELD OF THE INVENTION

The present invention relates to salesperson selecting, equipment for selecting a salesperson to carry out sales to a client.

### BACKGROUND OF THE INVENTION

Conventionally, systems of management data on customer data, salesperson data, etc. have been described in Japanese Patent Unexamined Publications Nos. 2001-350991, 2002-163567 and 2002-215885.

However, a supervisor in a sales department has made a selection or a decision of a salesperson to carry out a sales activity to a predetermined client, based on the supervisor's experience or intuition conventionally. In a method of making a selection of a salesperson based on experience or intuition in this way, for example, if a supervisor with little experience selects a salesperson, a proper salesperson may not be selected occasionally. Furthermore, even a supervisor with much experience cannot always select a proper salesperson in accordance with situations. There is a problem that if an improper salesperson is selected and such a salesperson carries out a sales activity to a client, the probability that business negotiation reaches an agreement decreases, thereby increasing the possibility that the sales activity ends in vain. When a sales activity does not succeed, a company that carries out the sales activity cannot make a profit by sales activities and thus net sales cannot be increased.

### SUMMARY OF THE INVENTION

Salesperson selecting equipment of the present invention includes a client data storage section for storing client data that are data on at least one client; a client assessment calculation section for calculating client assessment based on the client data; a salesperson data storage section for storing salesperson data of salespersons of a sales company; a salesperson assessment calculation section for calculating salesperson assessment based on the salesperson data; a selecting section for selecting the salesperson based on the client assessment and the salesperson assessment; and an output section for outputting the results selected by the selecting section. By using the salesperson selecting equipment of the present invention, it is possible to select a salesperson suitable for a sales activity to a predetermined client. Then, the selected salesperson carries out the sales activity, whereby the sales activity can be carried out effectively.

### BRIEF DESCRIPTION OF THE DRAWINGS

FIG. 1 is a block diagram showing a configuration of salesperson selecting equipment according to an embodiment of the present invention.

FIG. 2 is a flowchart showing an operation of salesperson selecting equipment according to an embodiment of the present invention.

FIG. 3 is a view showing a configuration of a system including salesperson selecting equipment according to an embodiment of the present invention.

FIG. 4 is a view showing an example of client data according to an embodiment of the present invention.

FIGS. 5A and 5B are views respectively showing an example of an assessment table according to an embodiment of the present invention.

FIG. 6 is a view showing an example of assessment according to an embodiment of the present invention.

FIG. 7 is a view showing an example of client data according to an embodiment of the present invention.

FIG. 8 is a view showing an example of client data according to an embodiment of the present invention.

FIG. 9 is a view showing an example of assessment according to an embodiment of the present invention.

FIG. 10 is a view to illustrate a method for calculating a level according to an embodiment of the present invention.

FIG. 11 is a view showing an example of client data according to an embodiment of the present invention.

FIG. 12 is a view showing an example of salesperson performance data according to an embodiment of the present invention.

FIG. 13 is a view showing an example of assessment according to an embodiment of the present invention.

FIG. 14 is a view showing an example of salesperson data according to an embodiment of the present invention.

FIG. 15 is a view showing an example of salesperson data according to an embodiment of the present invention.

FIG. 16 is a view showing an example of a display of a salesperson selecting screen according to an embodiment of the present invention.

FIG. 17 is a flowchart to illustrate a detail of a selection processing according to an embodiment of the present invention.

FIGS. 18A, 18B and 18C are views respectively showing an example of a selecting table according to an embodiment of the present invention.

FIGS. 19A and 19B are views respectively showing an example of salesperson data according to an embodiment of the present invention.

FIG. 20 is a view showing an example of a display of selected results according to an embodiment of the present invention.

### DESCRIPTION OF THE INVENTION

In order to achieve the above-mentioned object, salesperson selecting equipment according to the present invention includes a client data storage section for storing client data; a client assessment calculation section for calculating client assessment; a salesperson data storage section for storing salesperson data; a salesperson assessment calculation section for calculating salesperson assessment for each of the salespersons; a selecting section for selecting the salesperson to carry out sales to the client; and an output section for outputting results selected. According to such a configuration, it is possible to select a salesperson suitable for carrying out a sales activity to a predetermined client. Then, the selected salesperson carries out a sales activity, whereby an effective sales activity can be carried out.

Furthermore, in the salesperson selecting equipment of the present invention, the client assessment may be assessment on the client company and/or assessment on a person in charge at the client company. According to the present invention, the client assessment can be calculated by classifying it into, for example, assessment on the client company and assessment on a person in charge at the client company. When both are used, a more appropriate selection can be made.

Furthermore, in the salesperson selecting equipment of the present invention, the salesperson data may include salesperson individual data that are individual data of each of the salespersons and/or salesperson performance data that are data on sales performance of each of the salespersons. According to the present invention, the salesperson assessment can be calculated based on, for example, the salesperson individual data and salesperson performance data, thus enabling a more appropriate selection.

Furthermore, in the salesperson selecting equipment of the present invention, the salesperson data may include data on a type of business; the salesperson assessment calculation section may calculate the salesperson assessment for each type of business; and the selecting section may make a selection for each type of business. Since the experience and ability of a salesperson differs from one type of business to another, by selecting a salesperson for each type of business according to the present invention, more appropriate selection can be made.

Furthermore, in the salesperson selecting equipment of the present invention, the salesperson assessment calculation section may calculate the salesperson assessment based on the client data and salesperson data. According to the present invention, for example, the salesperson assessment can be calculated based on the contents of sales which a salesperson carried out in the past or on the data on the client. Thereby, more appropriate sales assessment can be calculated.

Furthermore, the salesperson selecting equipment according to the present invention may further include a sales matter data receiving section for receiving sales matter data that are data on a sales matter of a sales activity carried out to the client, and the selecting section may make the selection based on the sales matter data in addition to the client assessment and the salesperson assessment. According to the present invention, it is possible to make a selection of a salesperson suitable for carrying out the sales as to specific sales matters, thus enabling a more appropriate selection.

### Embodiment

Salesperson selecting equipment according to an embodiment of the present invention is described with reference to the drawings.

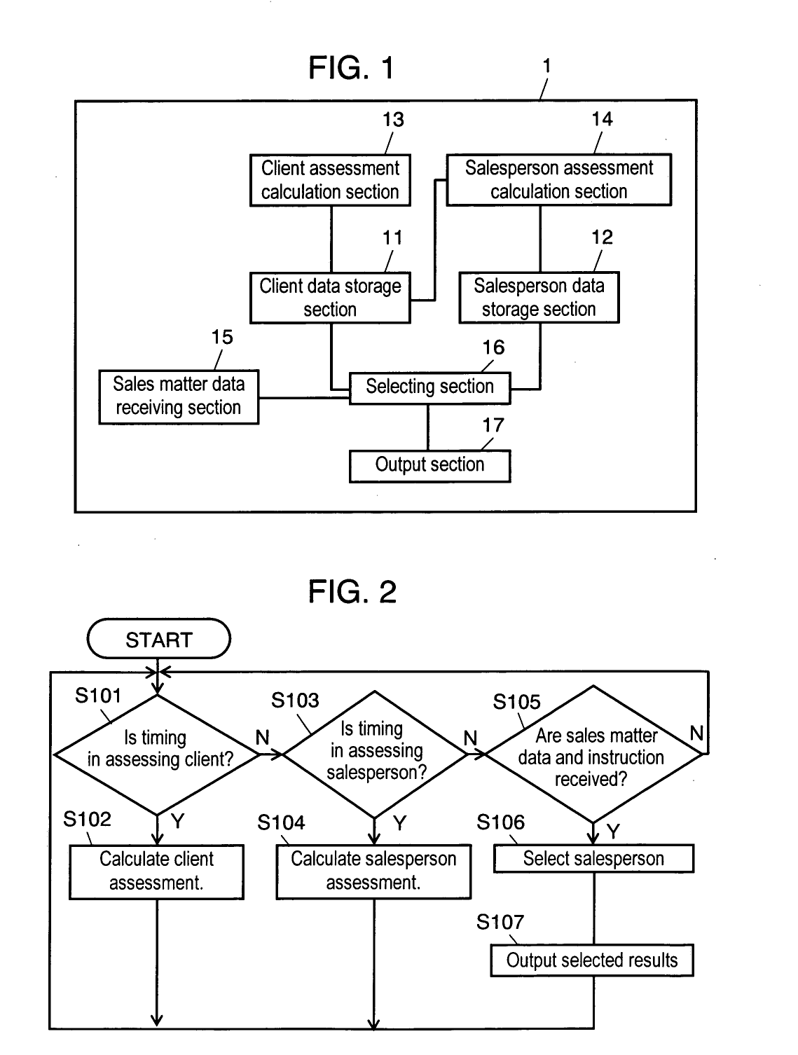

FIG. 1 is a block diagram showing a configuration of salesperson selecting equipment according to first embodiment. As shown in FIG. 1, salesperson selecting equipment 1 of first embodiment includes client data storage section 11, salesperson data storage section 12, client assessment calculation section 13, salesperson assessment calculation section 14, sales matter data receiving section 15, selecting section 16 and output section 17.

Client data storage section 11 stores client data on one or more clients. These client data include client company data and/or client person-in-charge data at the company of the client. In first embodiment, the case where the client data include the client company data and the client person in charge data is described. Herein, the client company data are data on, for example, capital stock, net sales, number of employees, and the like of the client company. The client person in charge data are data on, for example, official position, having or not having settlement authority in payment, and the like of the person in charge at the client.

Salesperson data storage section 12 stores salesperson data on a plurality of salespersons of a sales company. These salesperson data include salesperson individual data and/or salesperson performance data. In this embodiment, the case where the salesperson data include both the salesperson individual data and the salesperson performance data is described. Herein, the sales company denotes a company etc. that carries out a sales activity to the client company, and the salesperson denotes a person in charge of carrying out the sales activity to the client. From the salesperson individual data, it is possible to know the individual data of the salesperson, that is, official position, experience, and the like. From the salesperson performance data, it is possible to know data on sales activities which the salesperson carried out, that is, amount of money as to a predetermined sales matter, type of business, number of times the salesperson visits to the client.

Note here that client data storage section 11 and salesperson data storage section 12 can be achieved by semiconductor memory or by external storage units such as: hard disk drives, removable hard disk drives, optical disk drives using magnetic or optical media. Furthermore, the memory in client data storage section 11 and salesperson data storage section 12 may be temporary memory in RAM, etc. or may be a long-term memory in a magnetic disk, ROM, etc. of client data read out from an external storage device, etc. Furthermore, storage sections of client data storage section 11 and salesperson data storage section 12 may be achieved by the same recording medium. In this case, for example, a region in which client data are stored is named as client data storage section 11.

Furthermore, data structures of the client data and the salesperson data are not particularly limited. That is to say, items (fields) included in the client data, etc., the order of the items, number of bytes assigned to each item of data (attribute value) can be arbitrarily set.

Furthermore, a data management section (not shown) may form a new record or may update a stored record in the salesperson data and the client data, etc., based on reports of the sales activities (for example, a daily report).

Client assessment calculation section 13 calculates client assessment based on the client data stored in client data storage section 11. This calculated client assessment is also stored in client data storage section 11.

Salesperson assessment calculation section 14 calculates salesperson assessment for each salesperson based on the client data stored in client data storage section 11 and the salesperson data stored in salesperson data storage section 12. This calculated salesperson assessment is also to be stored in salesperson data storage section 12.

Note here that a method of expressing the client assessment and the salesperson assessment is not particularly limited and this assessment may be expressed by a numerical value or by a string of alphabet characters, etc. Furthermore, a method for calculating the assessment is not particularly limited and may be calculated by using a predetermined table or by using a predetermined function. A specific example of calculation of the client assessment, etc. will be described later.

Sales matter data receiving section 15 receives sales matter data. Herein, the sales matter data are data on matters of a sales activity carried out to the client. These sales matter data include, for example, a name of the client company, a name of a person in charge at the client company, amount of money of the subject of the sales activity, and the like. Furthermore, sales matter data receiving section 15 receives also an instruction to make a selection. Sales matter data receiving section 15 may receive sales matter data input from, for example, an input device (ex., a keyboard, a mouse, a touch panel, etc.), or may receive sales matter data, etc. sent via a wired or wireless communication line, or may receive sales matter data read out from a predetermined recording medium (for example, an optical disk, a magnetic disk, a semiconductor memory, etc.).

Selecting section 16 selects the salesperson to carry out sales to the client, based on the client assessment calculated by client assessment calculation section 13, salesperson assessment calculated by salesperson assessment calculation section 14 and sales matter data received by sales matter data receiving section 15.

Output section 17 outputs results selected by selecting section 16. According to this output, for example, a user, who gave an instruction to make a selection of a salesperson, is allowed to know who is a proper salesperson to carry out sales to the client. Herein, this output may be displayed on a display device (for example, CRT, liquid crystal display, EL display, etc.), or may be sent to a predetermined apparatus via a communication line, or may be printed by a printer, or may be output as voice data by a speaker. Note here that output section 17 may include a device for carrying out an output (for example, a display device, or a printer, etc.) or may not include. Furthermore, output section 17 may be achieved by hardware or by software such as a driver for driving the device.

Next, the operation of the salesperson selecting equipment according to this embodiment is described with reference to a flowchart shown in FIG. 2.

(Step S101) Client assessment calculation section 13 judges whether or not the timing is in assessing a client. When it is judged that the timing is in assessing a client, the step goes to step S102, and when it is judged that the timing is not in assessing a client, the step goes to step S103. Herein, the timing of assessing the client may be at regular periods (for example, at 2:00 a.m. on the first day of every month), or may be triggered by a predetermined event (for example, modification of client data), or may be at any other timing.

(Step S102) Client assessment calculation section 13 calculates client assessment based on the client data and stores the calculated client assessment in client data storage section 11. Then, the step returns to step S101.

(Step S103) Salesperson assessment calculation section 14 judges whether or not the timing is in assessing the client. When it is judged that the timing is in assessing a salesperson, the step goes to step S104, and when it is judged that the timing is not in assessing a salesperson, the step goes to step S105. Herein, the timing of assessing the salesperson may be at regular periods (for example, at 2:00 a.m. every Mondays) or may be triggered by a predetermined event (for example, modification of the salesperson data, etc.) or may be at any other timing.

(Step S104) Salesperson assessment calculation section 14 calculates salesperson assessment based on the client data and the salesperson data and stores the calculated salesperson assessment in salesperson data storage section 12. Then, the step returns to step S101.

(Step S105) Sales matter data receiving section 15 judges whether or not sales matter data and an instruction to make a selection were received. When it is judged that they were received, sales matter data receiving section 15 transmits the received sales matter data and the instruction to selecting section 16. Then, the step goes to step S106. When it is judged that they are not received, the step returns to step S101.

(Step S106) Selecting section 16 selects the salesperson to carry out sales to the client, based on the sales matter data, the client assessment and the salesperson assessment.

(Step S107) Output section 17 outputs the results selected by selecting section 16. Then, the step returns to step S101.

As described above, a method for selecting a salesperson according to the present invention includes a client assessment calculation step of calculating client assessment based on the client data that are data on one or more clients; a salesperson assessment calculation step of calculating salesperson assessment based on the salesperson data of a plurality of salespersons at the sales company; a selecting step of selecting a salesperson to the client based on the client assessment and the salesperson assessment; and an output step of outputting the results selected by the selecting step.

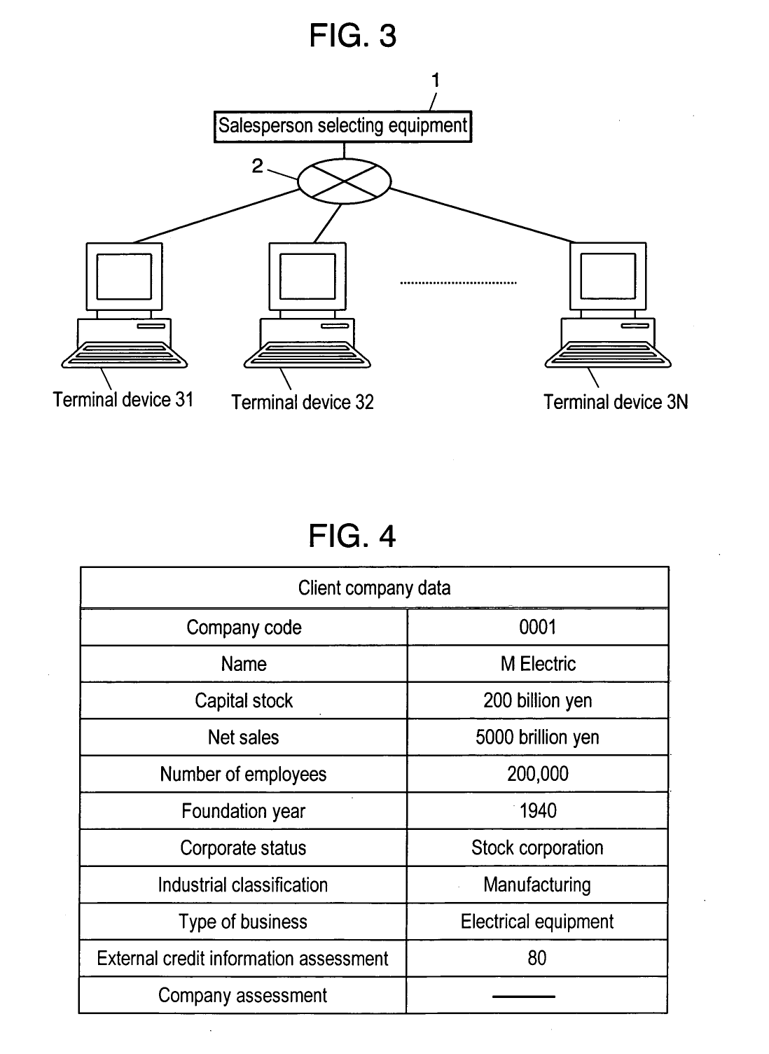

Next, the operation of the salesperson selecting equipment according to this embodiment is described by way of specific examples. In this specific example, as shown in FIG. 3, a system includes salesperson selecting equipment 1 and a plurality of terminal devices 31, 32 and 3N, etc., which are connected to via communication line 2. Communication line 2 is, for example, the Internet and intranet and may be wired or wireless.

Firstly, the calculation of the client assessment is described.

It is assumed that client company data are newly stored in client data storage section 11. FIG. 4 is a view showing the client company data. Herein, the client company data include “name,” “capital stock”, “net sales,” or the like of the client company. “External credit information assessment” in the client company data denotes an assessment value of credit information of the client company by an external assessment agency (for example, an agency carrying out a credit investigation, etc. of corporations). Note here that the client company data shown in FIG. 4 are one of the records included in the client company data. The client data stored in client data storage section 11 may include a record of the client company data other than those shown in FIG. 4.

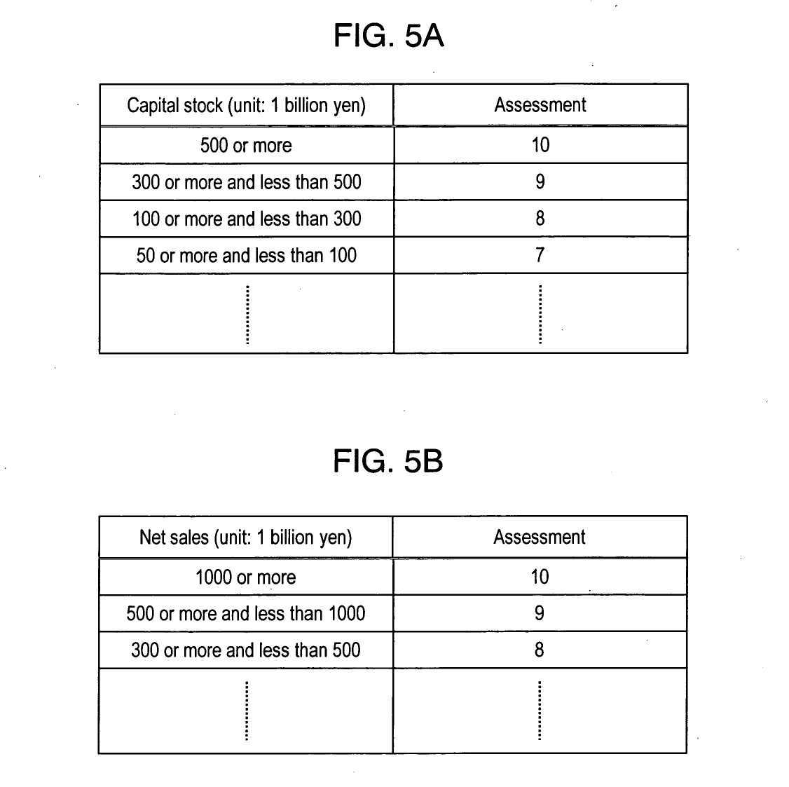

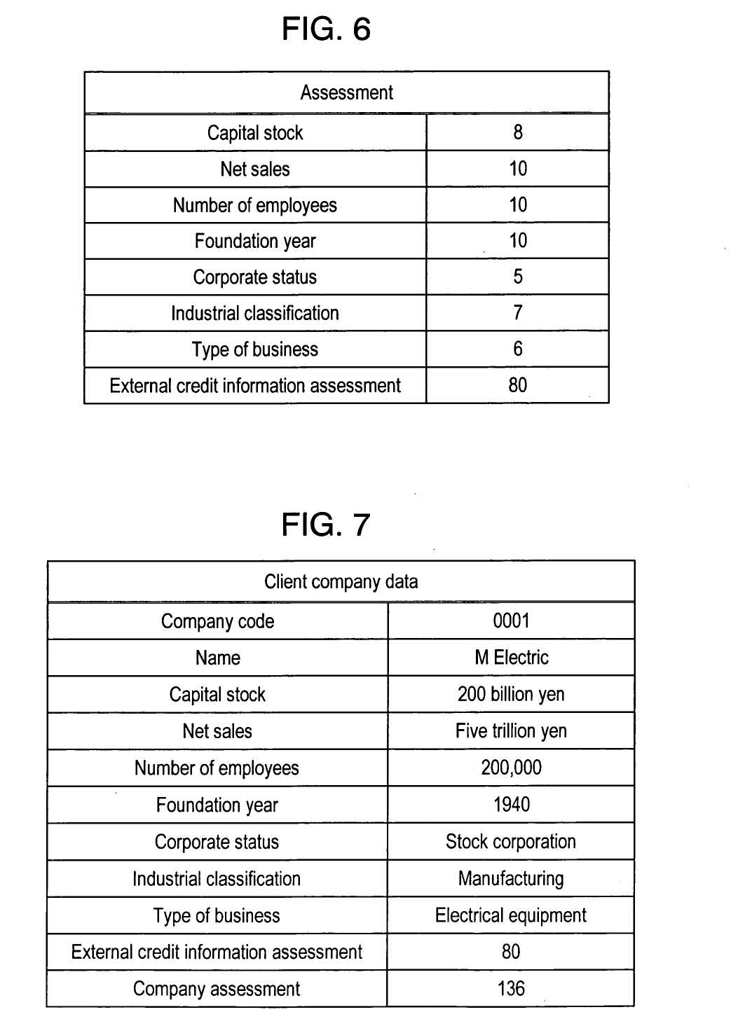

When client assessment calculation section 13 detects that the client company data shown in FIG. 4 are newly stored in client data storage section 11, it judges that the timing is in calculating client assessment (step S101) and calculates the company assessment included in the client assessment. Herein, as to the calculation of this company assessment, client assessment calculation section 13 firstly judges assessment of each item by using an assessment table. FIGS. 5A and 5B are views respectively showing a part of an assessment table held by client assessment calculation section 13. Since the client company data shown in FIG. 4 indicates that the capital stock is “200 billions yen,” client assessment calculation section 13 judges that the assessment of the capital stock is “8” with reference to the assessment table shown in FIG. 5A. Furthermore, the client company shown in FIG. 4 indicates that the net sales is “5000 billion yen,” client assessment calculation section 13 judges that the assessment of the net sales is “10” with reference to the assessment table shown in FIG. 5B. Thus, client assessment calculation section 13 judges that the assessment of each item of the client company data shown in FIG. 4 turns out to be results shown in FIG. 6.

Thereafter, client assessment calculation section 13 calculates the total of the assessment values so as to obtain the total value, “136.” This total value, “136” is recorded corresponding to “company assessment” in the client company data. The thus obtained client company data of “M Electric” is shown in FIG. 7 (step S102).

Then, the calculation of the client person in charge data is described.

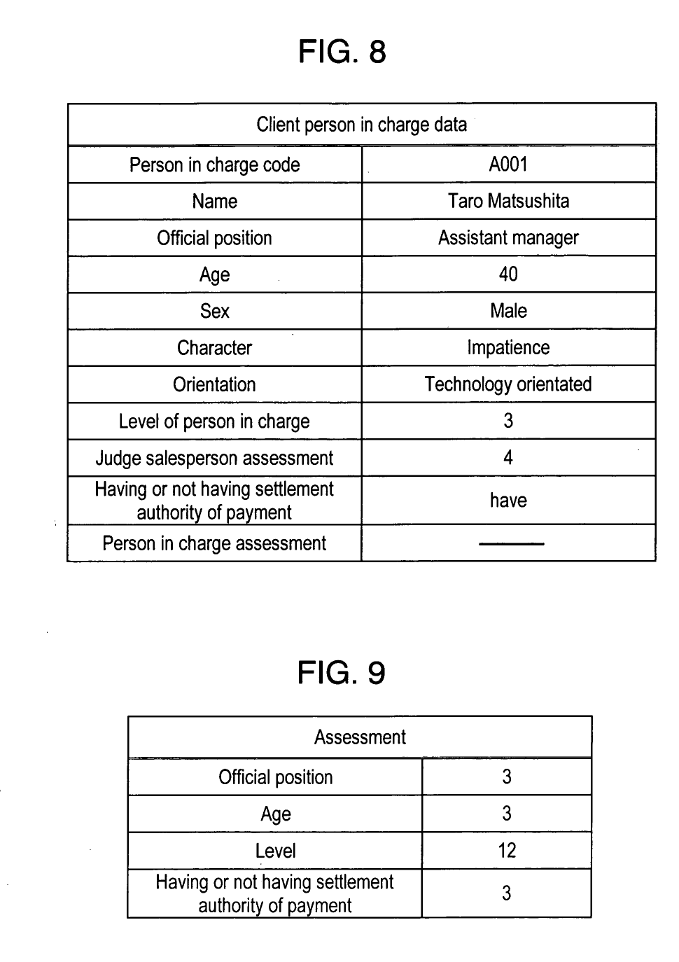

It is assumed that the client person in charge data shown in FIG. 8 are newly stored in client data storage section 11. The client person in charge data shown in FIG. 8 include “name,” “official position,” “age,” or the like of the person in charge at the client. Herein, “judge salesperson assessment” denotes salesperson assessment to a salesperson who judges “level of a person in charge” in the client person in charge data.

Note here that “salesperson assessment” will be described later. Furthermore, the client person in charge data shown in FIG. 8 are one of the records included in the client person in charge data. The client data stored in client data storage section 11 may include a record of the client person in charge data other than those shown in FIG. 8.

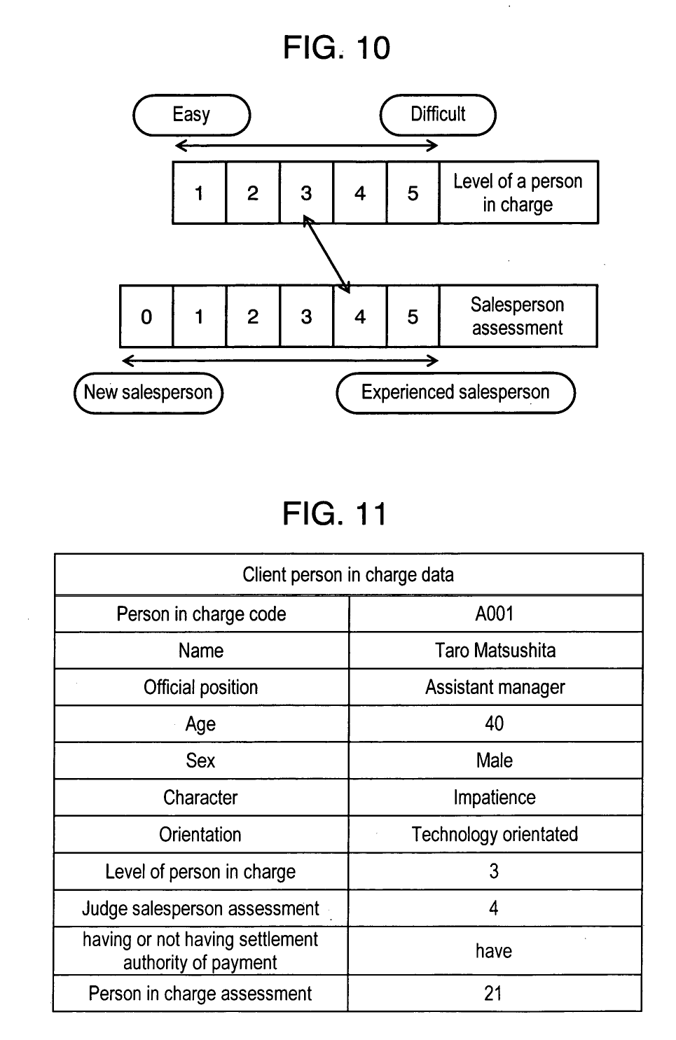

When client assessment calculation section 13 detects that the client person in charge data shown in FIG. 8 are newly stored in client data storage section 11, it judges that the timing is in calculating the client assessment (step S101) and calculates the person in charge assessment included in the client assessment. Also in this calculation of the person in charge assessment, first of fall, by using an assessment table similar to that shown in FIG. 5, judging of assessment of each item is carried out. As a result, it is assumed to be judged that the assessment of each item turns out to be as shown in FIG. 9. The “lever” in FIG. 9 is calculated as a product of the level of the person in charge and the salesperson assessment of the salesperson who judges the level of the person in charge. As shown in FIG. 10, when a salesperson having the salesperson assessment of “4” judges that the level of the person in charge at the client is “3”, the “level” becomes 12(=4∴3). Therefore, the value the “level,” which was assessed by an experienced salesperson, becomes high and the value of the “level,” which was assessed by a new salesperson, becomes low. It is thought to be because the reliability of the judgment by an experienced salesperson is high but that by a new salesperson is low.

Thereafter, client assessment calculation section 13 calculates the total value “21” of the assessment shown in FIG. 9 and the total value “21” is recorded corresponding to “assessment of person in charge” in the client person in charge data. As a result, the client person in charge data of “Taro Matsushita” shown in FIG. 11 is obtained (step S102).

“Company assessment” in the client company data shown in FIG. 7 and “person in charge assessment” in the client person in charge data shown in FIG. 11 are the client assessment calculated in the client assessment calculation section 13. That is to say, the client assessment includes the company assessment and the person in charge assessment.

Then, the calculation of the salesperson assessment is described.

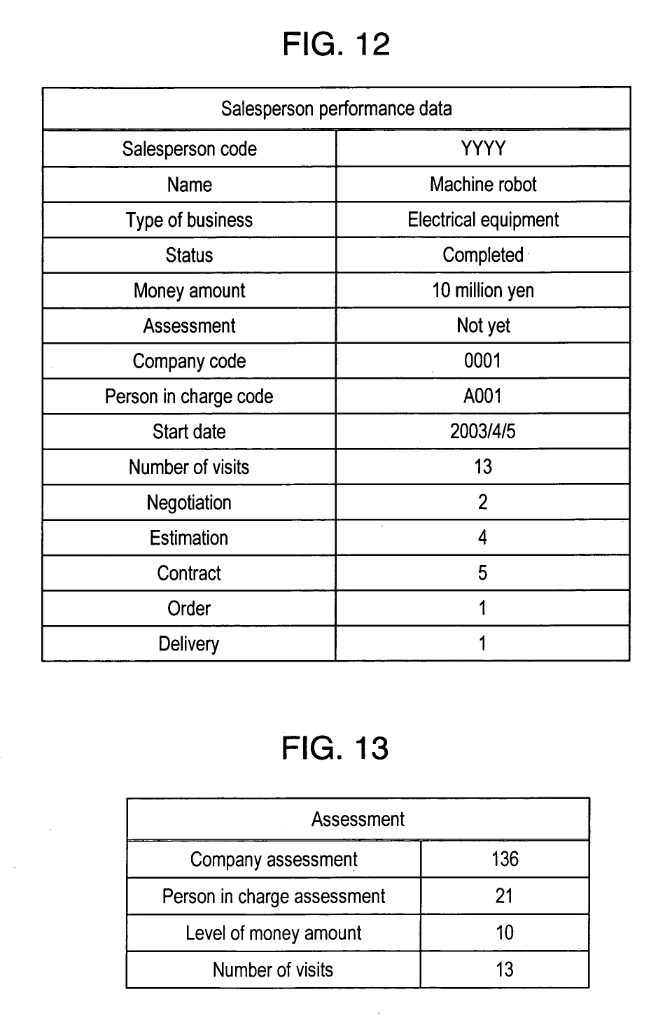

FIG. 12 shows salesperson performance data included in the salesperson data stored in salesperson data storage section 12. Herein, the salesperson performance data include “name,” “type of business,” “status,” or the like of the sales matter. The “status” in this salesperson performance data denotes a status regarding the sales matter shown in these salesperson performance data. “Completed” means that the sales activity regarding the sales matter has been completed. “Assessment” shows whether or not the assessment on this salesperson performance data was carried out. Furthermore, “number of visits” denotes a number of times the salesperson visits to the client and is shown corresponding to the classification of the visit, i.e., “negotiation,” “quotation,” and the like. Note here that salesperson performance data shown in FIG. 12 show one of the records included in the salesperson performance data. The salesperson performance data included in the salesperson data stored in salesperson data storage section 12 may include a record of salesperson performance data other than those shown in FIG. 12.

It is assumed that in the salesperson performance data shown in FIG. 12, the “status” has been just changed from “delivery” to “completed.” Salesperson assessment calculation section 14 detects that the “status” has been changed to “completed” and that assessment has not been carried out yet (that is, the “assessment” shows “not yet”), judges that the timing is in calculating the salesperson assessment (step S103) and calculates the salesperson assessment.

Firstly, salesperson assessment calculation section 14 obtains the company assessment with reference to the client company data shown in FIG. 7 corresponding to a company code “0001” in the salesperson performance data shown in FIG. 12. Furthermore, salesperson assessment calculation section 14 obtains the person in charge assessment with reference to the client person in charge data shown in FIG. 11, corresponding to a person in charge code “A001” in the salesperson performance data shown in FIG. 12. Furthermore, salesperson assessment calculation section 14 calculates a level of amount from “10 million yen” of the salesperson performance data shown in FIG. 12. The level of money amount is calculated by dividing the money amount in the salesperson performance data by “1 million yen.” Therefore, in the case of FIG. 12, the level of money amount is calculated to be “10.” Furthermore, salesperson assessment calculation section 14 obtains the number of visits, “13.” The assessment, which was obtained or calculated in this way, is shown in FIG. 13. Salesperson assessment calculation section 14 calculates an experience value of the salesperson based on the assessment shown in FIG. 13 from the following equation:
Experience value=(company assessment+level of money amount)/(number of visits−5)+person in charge assessment

Herein, the reason for subtracting “5” from the number of visits is thought to be because the salesperson visits at least five times including negotiation, quotation, contract, order and delivery, and therefore by subtracting 5 from the number of visits, excess times of visits can be calculated. The reason why the experience value is calculated to be low as the number of visits increases is thought to be because the increased numbers of visits mean the sales activity to be insufficient.

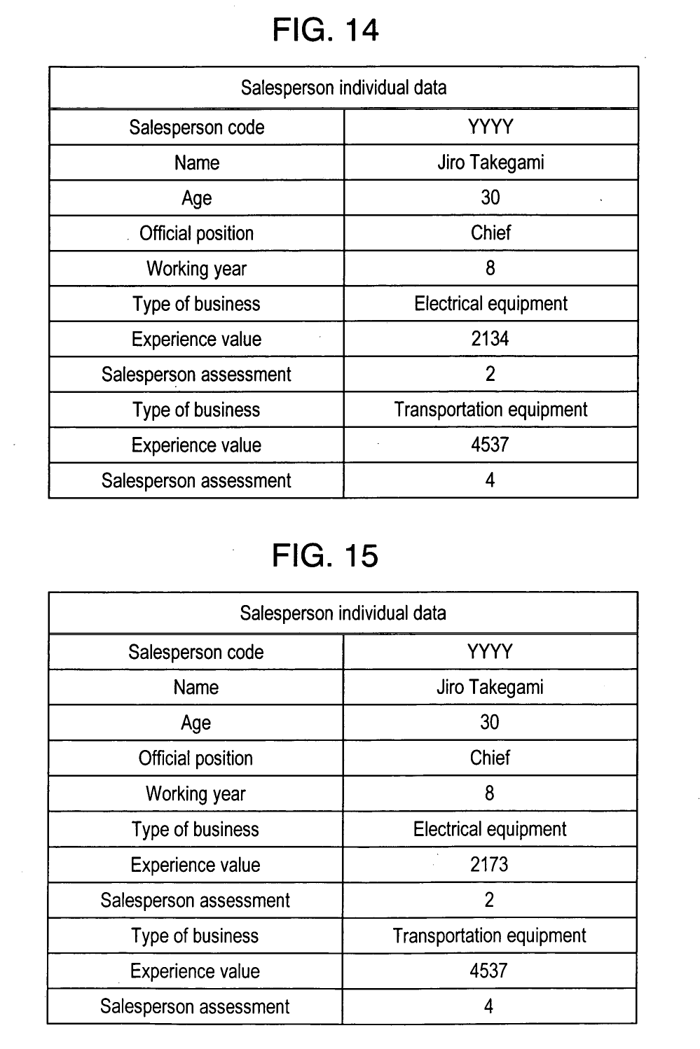

When the assessment values in FIG. 13 are substituted into the above-mentioned equation of experience value so as to calculate the experience value, “39.25” “39” is obtained. Salesperson assessment calculation section 14 adds the calculated experience value to the experience value corresponding to the type of business: “electronic equipment” of a salesperson having a salesperson code “YYYY” When the salesperson individual data shown in FIG. 14 is assumed to be included in the salesperson data stored in salesperson data storage section 12, salesperson assessment calculation section 14 adds “39” to the experience value “2134⇄ corresponding to a type of business: “electronic equipment” in the salesperson individual data shown in FIG. 14. As a result, the experience value “2173” is obtained, and the salesperson individual data are updated as shown in FIG. 15. Herein, the salesperson assessment for each type of business can be calculated as a quotient obtained by dividing the experience value in the type of business by “1000.” Therefore, in the above case, even if the experience value is added, the salesperson assessment is not updated. Thereafter, salesperson assessment calculation section 14 updates the assessment of the salesperson performance data shown in FIG. 12 to “already done.” Note here that the salesperson individual data shown in FIGS. 14 and 15 are one of the records included in the salesperson individual data, and the salesperson individual data stored in salesperson data storage section 12 may include a record of the salesperson individual data other than that shown in FIGS. 14 and 15.

Then, the operation of selection of the salesperson in selecting section 16 is specifically described with reference to Example.

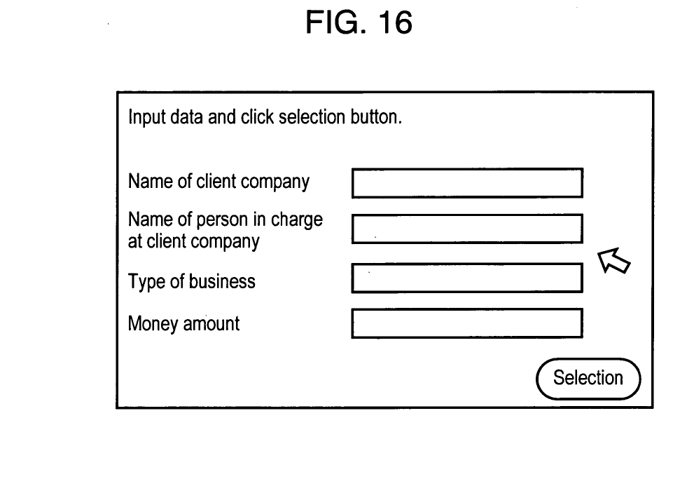

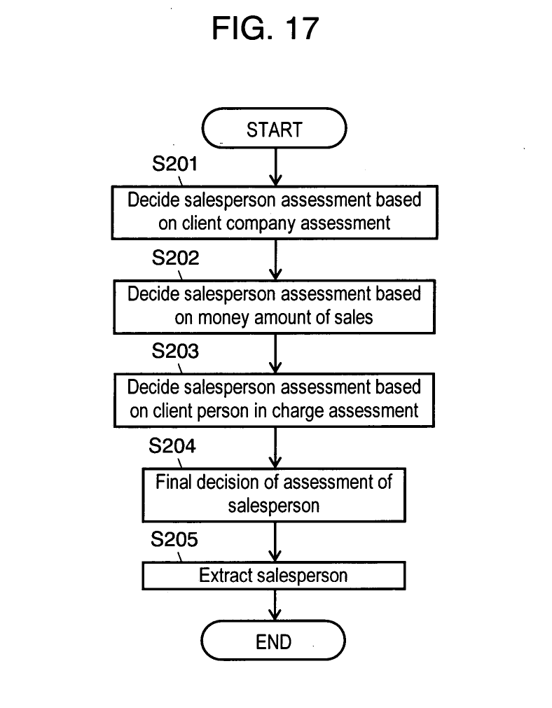

Example assumes that a user, who wants to make a selection of a salesperson, operates terminal device 31 so as to display a salesperson selecting screen shown in FIG. 16 on a display of terminal device 31. Example assumes that, on the display of FIG. 16, the user inputs “name of client company: M Electric”, “name of person in charge: Taro Matsushita,” “type of business: electrical equipment” and “money amount: 12 million yen” by operating a keyboard, and clicks a “select” button by a mouse. According to this operation, sales matter data including the mane of the client company, etc. and the instruction to make a selection of the salesperson are sent to salesperson selecting equipment 1 and received by sales matter data receiving section 15 (step S105). Then, based on the sales matter data, the selection at selecting section 16 is made (step S106). FIG. 17 is a flowchart to illustrate the detail of the selecting processing.

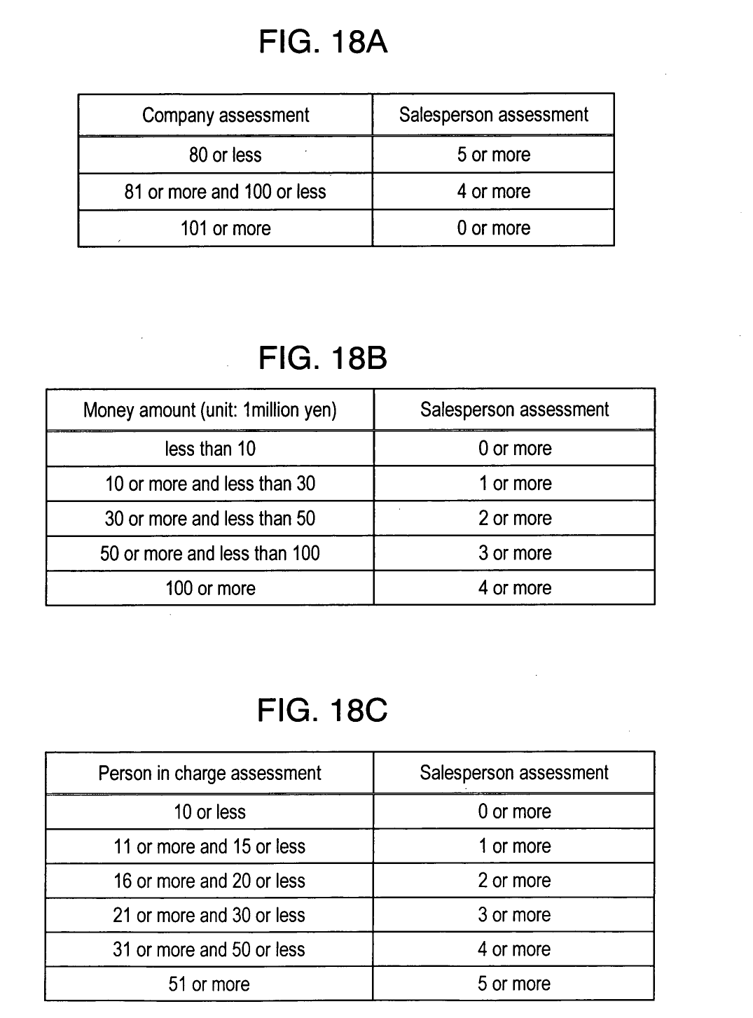

Selecting section 16 firstly obtains the company assessment, “136” with respect to the client company name: “M Electronics” included in the sales matter data with reference to the client company data shown in FIG. 7 stored in client data storage section 11. The salesperson assessment corresponding to the company assessment value, “136” is decided with reference to a selecting table shown in FIG. 18A possessed by selecting section 16. In this case, since the company assessment value of “M Electric” is 136, the salesperson assessment is decided to be zero or more (Step S201). Herein, since the minimum value of the salesperson assessment is “0,” the salesperson assessment “0” substantially means that any salesperson may be selected.

Next, selecting section 16 decides the salesperson assessment corresponding to the money amount: “12 million yen” included in the sales matter data with reference to a selecting table shown in FIG. 18B possessed by selecting section 16. In the case where the money amount is “12 million yen”, the salesperson assessment is decided to be one or more (step S202).

Then, the selecting section 16 obtains the person in charge assessment “21” with respect to the client person in charge who's name: “Taro Matsushita” included in the sales matter data with reference to the client person in charge data shown in FIG. 11 stored in client data storage section 11. Then, the salesperson assessment corresponding to the person in charge assessment “21” is decided with reference to a selecting table shown in FIG. 18C possessed by selecting section 16. In the case of “Taro Matsushita,” the salesperson assessment is decided to be three or more (step S203).

Based on the thus decided salesperson assessment, selecting section 16 decides a final salesperson assessment. In the case of Example, the final salesperson assessment is decided to be “three or more” as a common part of the obtained assessment values “0 or more,” “one or more,” and “three or more” (step S204). Note here that the common part denotes an assessment value included in any of the above-mentioned three assessments.

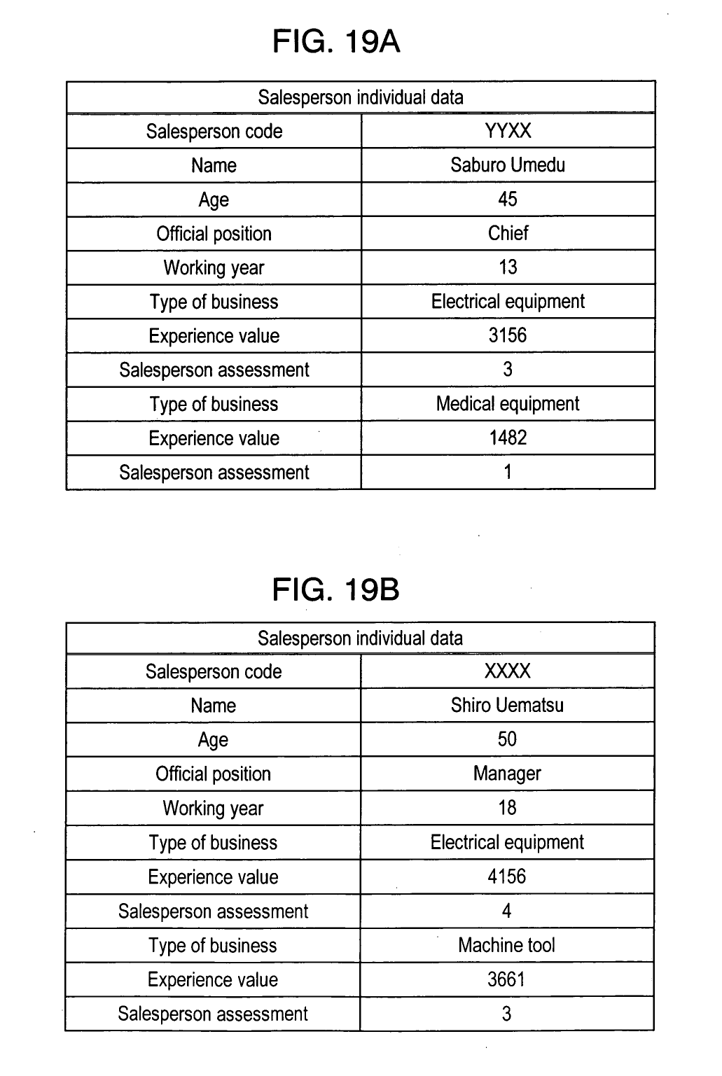

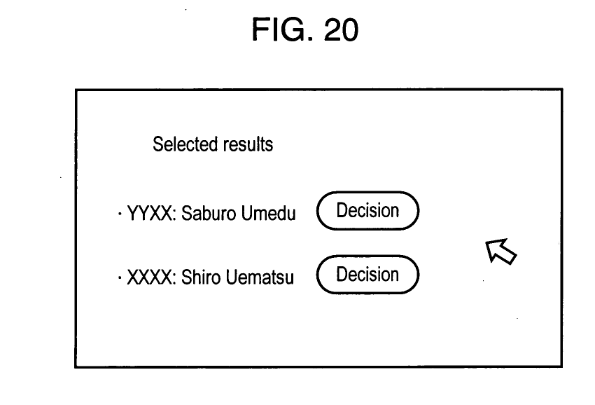

Then, selecting section 16 extracts a salesperson code and a name of a salesperson having the salesperson assessment: “three or more” corresponding to the type of business: “electrical equipment” included in the sales matter data, with reference to the salesperson individual data stored in salesperson data storage section 12. When the salesperson individual data shown in FIGS. 19A and 19B are included in the salesperson individual data, selecting section 16 extracts the salesperson code “YYXX” and the name “Saburo Umedu” as well as the salesperson code “XXXX” and the name “Shiro Uematsu” (Step S205). Then, output section 17 sends data showing the results selected by selecting section 16 to terminal device 31 to which the sales matter data are sent (step S107). Then, a display shown in FIG. 20 is provided on terminal device 31, whereby a user who makes a selection of a salesperson can know the selected results.

Furthermore, the user clicks a “select” button shown in FIG. 20, whereby the decided results are sent to salesperson selecting equipment 1, so that salesperson performance data on the sales matter may be automatically formed in salesperson selecting equipment 1. In this case, salesperson selecting equipment 1 has further a salesperson decision receiving section (not shown), and the salesperson decision receiving section can receive the decision results regarding one or two or more of salespersons decided by a user from the salespersons output as selection results.

Note here that calculation of the experience value of the salesperson, calculation of the client assessment, calculation of the salesperson assessment and selection of the salesperson are not limited to Example. That is to say, the experience value of the salesperson may be calculated by using a function other than the above-mentioned equation, or a predetermined table, etc. The client assessment may be calculated by using a table other than that shown in FIG. 5, or a predetermined function, etc. The salesperson assessment may be calculated from other than experience value (by using, for example, a table or a function, etc. based on the client assessment and the salesperson performance data). The selection of the salesperson may be made by using a table other than that shown in FIG. 18, or a predetermined function, etc.

Furthermore, in the above-mentioned specific example, the case where experience value and the salesperson assessment are calculated for each type of business was described. However, the salesperson assessment, etc. may be calculated all together for each salesperson. In this case, the sales matter data may not include a type of business.

Furthermore, in the above-mentioned Example, the case where the salesperson assessment is calculated by using the company assessment and the person in charge assessment, etc. was descried. However, the salesperson assessment may be calculated based on the capital stock, etc. included in the client data without using the company assessment, etc.

As mentioned above, according to the salesperson selecting equipment of this embodiment, the client assessment is calculated based on the client data, the salesperson assessment is calculated based on the salesperson data, and the salesperson is selected based on the client assessment, the salesperson assessment and the sales matter data, whereby it is possible to appropriately select the salesperson suitable for carrying out sales to a client. In particular, since it is possible to select the salesperson without relying upon experience or intuition, even a person with little experience can make a selection of a proper salesperson. Furthermore, it is possible to avoid an inappropriate selection due to the feeling at the time of selection. As a result, effective sales activity can be carried out, thereby increasing the probability that negotiation is concluded. Consequently, the increase in net sales and profit can be expected.

Note here that in this embodiment, the case where the salesperson is selected by using sales matter data was described, however, the salesperson may be selected not based on sales matter data. For example, except in the case where the salesperson is selected with respect to a predetermined sales matter, in the case where the matching of congenialities between the salesperson and the client company, the person in charge, and the like is evaluated, the selecting section 16 may select the salesperson based on the client assessment and the salesperson assessment.

Furthermore, in this embodiment, the case where sales matter data receiving section 15 receives an instruction to make a selection of the salesperson and sales matter data was described. However, the sales matter data receiving section 15 may receive only sales matter data, and selecting section 16 may judge that an instruction to make a selection of the salesperson is made when sales matter data receiving section 15 receives sales matter data.

Furthermore, in this embodiment, the case where the salesperson assessment is calculated based on the salesperson data and the client data (in particular, the client assessment included in the client data) was described. However, the salesperson assessment may be calculated based on only the salesperson data.

Furthermore, in this embodiment, the case where the salesperson data include the salesperson performance data and the individual data of a salesperson was described. However, as mentioned above, the salesperson data may include only one of the salesperson performance data and the individual data of a salesperson. In the case where the salesperson data include only the salesperson performance data, the salesperson assessment may be calculated by obtaining the total assessment (corresponding to the experience value in the above-mentioned specific example) for each salesperson based on the salesperson performance data. In the case where the salesperson data include only the individual salesperson data, the salesperson assessment may be calculated by assessing the “official position,” “experience year” and the like by using a predetermined table and function, etc.

Furthermore, in this embodiment, the case where the salesperson assessment is calculated based on the salesperson data was described. However, the salesperson performance assessment may be calculated based on the salesperson performance data included in the salesperson data, and salesperson individual assessment may be calculated based on the salesperson individual data included in the salesperson data. In this case, the salesperson assessment includes the salesperson performance assessment and the individual salesperson assessment.

Furthermore, in this embodiment, the case where the calculated company assessment, person in charge assessment and salesperson assessment are stored in client data storage section 11 or salesperson data storage section 12 was described. However, this assessment may be stored separately from the client data etc. Alternatively, they may be directly transmitted to selecting section 16.

Furthermore, in this embodiment, each processing (each function) may be achieved by centralized processing by a single apparatus (or system), or may be realized by distributed processing using a plurality of apparatuses.

Furthermore, in this embodiment, each component may be constructed by special hardware or may be achieved by executing a program when the elements can be achieved by software. For example, each component can be achieved by a program executing section such as CPU that reads out a software program recorded in a recording medium such as, for example, hard disk, semiconductor, and the like and executes the program.

Note here that the software that achieves the data processing apparatus in this embodiment has a following program. That is to say, the configuration of this program allows a computer to execute a client assessment calculation processing for calculating client assessment based on client data that are data on one or more clients; a salesperson assessment calculation processing for calculating salesperson assessment for each salesperson based on the salesperson data that are data on a plurality of salespersons at sales company; a selection processing of a salesperson to a client based on the client assessment and the salesperson assessment; and an output processing for outputting the results selected by the selecting processing.

Note here that in the above-mentioned program, the output processing for outputting data does not include a processing carried out only by hardware, for example, an output processing carried out by a modem, an interface card, a display device, etc. (i.e. processing carried out only by hardware).

Furthermore, this program may be executed by downloading from a server, etc., or may be executed by reading out a program recorded in a predetermined recording medium (for example, an optical disk such as a CD-ROM, a magnetic disk, a semiconductor memory, etc.).

Furthermore, this program may be executed by a single computer or a plurality of computers. That is to say, centralized processing may be carried out, or distributed processing may be carried out.

As mentioned above, the salesperson selecting equipment etc. of the present invention can select a proper salesperson to carry out sales to a client and is useful in a system, etc. for selecting a salesperson.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. Salesperson selecting equipment, comprising:
a client data storage section for storing client data on at least one client;
a client assessment calculation section for calculating client assessment based on the client data;
a salesperson data storage section for storing salesperson data of a company;
a salesperson assessment calculation section for calculating salesperson assessment based on the salesperson data;
a selecting section for selecting the salesperson based on the client assessment and the salesperson assessment; and
an output section for outputting results selected by the selecting section.

2. The salesperson selecting equipment according to claim 1, wherein the client assessment is assessment on the client company and/or assessment on a person in charge at the company of the client.

3. The salesperson selecting equipment according to claim 1, wherein the salesperson data comprise salesperson individual data of each of the salespersons and/or salesperson performance data of each of the salespersons.

4. The salesperson selecting equipment according to claim 2, wherein the salesperson data comprise salesperson individual data of the salespersons and/or salesperson performance data that are data on sales performance of each of the salespersons.

5. The salesperson selecting equipment according to claim 1, wherein
the salesperson data comprise data on a type of business;
the salesperson assessment calculation section calculates the salesperson assessment for each of the type of business; and
the selecting section makes a selection for each of the type of business.

6. The salesperson selecting equipment according to claim 4, wherein
the salesperson data comprise data on a type of business;
the salesperson assessment calculation section calculates the salesperson assessment for each of the type of business; and
the selecting section makes a selection for each of the type of business.

7. The salesperson selecting equipment according to claim 1, wherein the salesperson assessment calculation section calculates the salesperson assessment based on the client data and the salesperson data.

8. The salesperson selecting equipment according to claim 6, wherein the salesperson assessment calculation section calculates the salesperson assessment based on the client data and the salesperson data.

9. The salesperson selecting equipment according to claim 1, further comprising a sales matter data receiving section,
the sales matter data receiving section receives sales matter data of a sales activity carried out to the client; and
the selecting section makes the selection based on the sales matter data in addition to the client assessment and the salesperson assessment.

10. The salesperson selecting equipment according to claim 8, further comprising a sales matter data receiving section,
the sales matter data receiving section receives sales matter data of a sales activity carried out to the client; and
the selecting section makes the selection based on the sales matter data in addition to the client assessment and the salesperson assessment.

11. The salesperson selecting equipment according to claim 1, further comprising a salesperson decision receiving section, wherein the salesperson decision receiving section receives decided result of at least one salesperson decided by a user from the salespersons output.

12. A method by computer for selecting a salesperson, the method comprising:
a client assessment calculation step of calculating client assessment based on the client data of at least one client;
a salesperson assessment calculation step of calculating salesperson assessment based on salesperson data on a plurality of salespersons at a sales company;
a selecting step of selecting the salesperson to carry out sales to the client, based on the client assessment and the salesperson assessment; and
an output step of outputting the results selected in the selecting step.

13. The method for selecting a salesperson according to claim 12, further comprising a salesperson deciding step, wherein a user can decide at least one salesperson from the salespersons included in the selected results output.

14. A program for automatically selecting a salesperson suitable for a client by using a computer, comprising:
a client assessment calculation processing for calculating client assessment based on client data that are data on one or more clients;
a salesperson assessment calculation processing for calculating salesperson assessment based on salesperson data that are data on a plurality of salespersons at a sales company;
a selection processing for selecting the salesperson to carry out sales to the client, based on the client assessment and the salesperson assessment; and
an output processing for outputting the selected results in the selecting step.
